(19) United States
(12) Patent Application Publication
(10) Pub. No.: US 2004/0040023 A1
(43) Pub. Date: Feb. 26, 2004

(54) Remote identification loader

(76) Inventors: David G. Ellis, Clifton Park, NY (US); Steve A. Schoenberg, Clifton Park, NY (US)

Correspondence Address: ARLEN L. OLSEN, SCHMEISER, OLSEN & WATTS, 3 LEAR JET LANE, SUITE 201, LATHAM, NY, 12110, US

(21) Appl. No.: 10/226,660

(22) Filed: Aug. 22, 2002

(51) Int. Cl. G06F 9/445

(52) U.S. Cl. 717/178; 717/174

(57) ABSTRACT

A system and method to remotely install software from a third device to a first device using identification information on a second device. The system and method do not require a user input to the first device.

### BACKGROUND OF THE INVENTION

1. Technical Field

The present invention relates to an apparatus and associated method to load files and/or other information into a computer or computing device.

2. Related Art

Installing or upgrading a computer or computing device typically requires a skilled person at the installation site to load files or other information into the computer or computing device. Requiring a skilled person to load files directly at the installation site may be very time consuming and therefore costly. Thus there is a need for an apparatus and associated method to load files or other information into a computer or computing device without the need for a skilled person on site.

### SUMMARY OF THE INVENTION

The present invention provides a system to remotely install software, comprising:

a first device, wherein the first device is adapted to receive software from a third device comprising the software over a communication link between the first device and the third device, wherein a second device is adapted to transmit identification information to the first device over a communication link between the first device and the second device or the second device is adapted to transmit identification information to the third device over a communication link between the second device and the third device, and wherein the identification information is adapted to initiate a download of the software from the third device to the first device over the communication link between the first device and the third device without a user input to the first device.

The present invention provides a system to remotely install software, comprising:

a third device, wherein the third device comprises software, wherein a second device is adapted to transmit identification information to a first device over a communication link between the first device and the second device or the second device is adapted to transmit identification information to the third device over a communication link between the second device and the third device, and wherein the identification information is adapted to initiate a download of the software from the third device to the first device over a communication link between the first device and the third device without a user input to the first device.

The present invention provides a system to remotely install software, comprising:

a second device, wherein the second device is adapted to transmit identification information to a first device over a communication link between the first device and the second device or the second device is adapted to transmit identification information to a third device over a communication link between the third device and the second device, wherein the third device comprises software, and wherein the identification information is adapted to initiate a download of the software from the third device to the first device over a communication link between the first device and the third device without a user input to the first device.

The present invention provides a system to remotely install software, comprising:

a first device, wherein the first device is adapted to receive software from a third device comprising the software over a communication link between the first device and the third device, wherein a storage device is electrically and mechanically attached to the first device, wherein the storage device is adapted to transmit identification information to the first device, and wherein the identification information is adapted to initiate a download of the software from the third device to the first device over the communication link between the first device and the third device without a user input to the first device.

The present invention provides a system to remotely install software, comprising:

a third device, wherein the third device comprises software, wherein a storage device is electrically and mechanically attached to a first device, wherein the storage device is adapted to transmit identification information to the first device, and wherein the identification information is adapted to initiate a download of the software from the third device to the first device over a communication link between the first device and the third device without a user input to the first device.

The present invention provides a method for installing software in a first device, comprising the steps of:

receiving, by the first device, identification information from a second device over a communication link between the first device and the second device or receiving, by a third device, identification information from the second device over a communication link between the third device and the second device; and

receiving the software, by the first device from the third device over a communication link between the first device and the third device, in accordance with the identification information and without user input to the first device.

The present invention provides a method for installing software in a first device, comprising the step of transmitting, by a second device, identification information to the first device over a communication link between the first device and the second device or transmitting, by the second device, identification information to a third device over a communication link between the second device and the third device, wherein the first device is adapted to receive the software from a third device over the communication link between the first device and the third device in accordance with the identification information and without user input to the first device.

The present invention provides a method for installing software in a first device, comprising the step of transmitting, by a third device, the software to the first device over a communication link between the first device and the third device without user input to the first device, in accordance with identification information received by the first device from a second device over a communication link between the first device and the second device or in accordance with identification information received by the third device from the second device over a communication link between the third device and the second device.

The present invention provides a method for installing software in a first device, comprising the steps of:

receiving, by the first device, identification information from a storage device that is electrically and mechanically attached to the first device; and

receiving the software, by the first device from a third device over a communication link between the first device and the third device, in accordance with the identification information and without user input to the first device.

The present invention provides a method for installing software in a first device, comprising the steps of transmitting, by a third device, the software to the first device over a communication link between the first device and the third device without user input to the first device, in accordance with identification information received from a storage device that is electrically and mechanically attached to the first device.

### BRIEF DESCRIPTION OF THE DRAWINGS

FIG. 1 depicts a block diagram view of a system to install software from a third device to a first device using identification information on a second device, in accordance with embodiments of the present invention.

FIG. 2 illustrates a variation of FIG. 1 showing a block diagram view of a system to install software from a third device to a first device using identification information on a storage device attached to the first device, in accordance with embodiments of the present invention.

FIG. 3 illustrates flowchart depicting an algorithm showing a first embodiment based on the system of FIG. 1, in accordance with embodiments of the present invention.

### DETAILED DESCRIPTION OF THE INVENTION

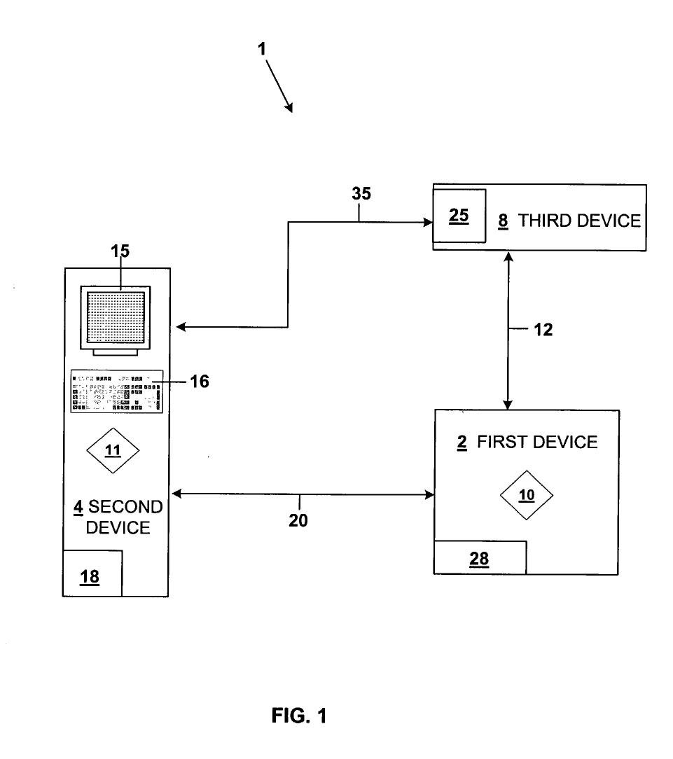

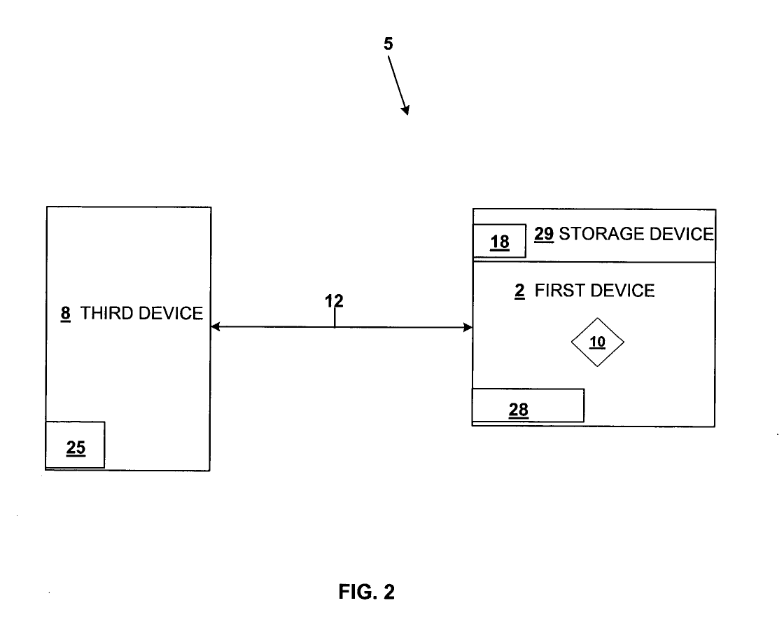

FIG. 1 illustrates a block diagram view of a system 1 to remotely install software 25 from a third device 8 to a first device 2 using identification information 18 on a second device 4, in accordance with embodiments of the present invention. “Software” is defined herein as information that is required by the first device 2 to perform functions and may include, inter alia, executable programs and procedures as well as data, databases, tables, files, etc. to which executable programs and procedures are coupled or related. “Identification information” is defined herein as instructions required to retrieve the “software” and may include, inter alia, address information, serial number, port number, etc. The first device 2 may be an embedded device (e.g., a device that runs without a display or human input). The embedded device may be an embedded controller. The embedded controller may be adapted to run on an embedded LINUX operating system. Alternatively, the first device 2 may be a computing device such as, inter alia, a computer or personal computer (PC). The first device 2 may comprise a central processing unit 10 (CPU) and a memory device 28. The first device 2 requires software 25 (e.g., operating system software, operating software (firmware), configuration files, etc) to become functional and perform specified functions on or by the first device 2. As a first example, a specified function may be to initialize hardware on the first device 2. As a second example, a specified function may be to control hardware on the first device 2. The required software 25 may be stored in the memory device 28 after the software 25 is received from the third device 8. The first device 2 may also require periodic upgrades to software already existing on the first device 2. The periodic upgrades may include, inter alia, upgrading software, scheduled software modifications (e.g., scheduled software updates, scheduled software maintenance, etc), process instructions, data, files, etc. The periodic upgrades may be performed automatically at any given time based on the identification information 18 provided by the second device 4. The first device 2 receiving the software 25 may pull the software 25 from the third device 8 into the first device 2 through a communication link 12 after the first device 2 receives the identification information 18 from the second device 4 through a communication link 20. Alternatively, the third device 8 may push the software 25 into the first device 2 through the communication link 12 after the third device 8 receives the identification information 18 from the second device 4 through a communication link 35. The communication link 12 may be a wireless link, a network link, a telephone link, an Internet link, a cable link, an Ethernet link, etc. The third device comprises memory including, inter alia, an electrically erasable programable read only memory (EEPROM), a compact flash card, flash memory, a memory stick, a multimedia memory card, a floppy disc drive, a hard disc drive, a compact disc drive, a digital video disc drive, etc. Optionally, the third device 8 may be a computer and comprise a CPU, an input device, an output device, and memory. The aforementioned input device may be any input device known to a person of ordinary skill in the art such as a keyboard, keypad, mouse, etc. The aforementioned output device may be any output device known to a person of ordinary skill in the art such as a monitor, printer, liquid crystal display, etc. The second device 4 comprises identification information 18. The identification information 18 may have been entered into the second device 4 by, inter alia, a user through use of an input device 16. The identification information 18 may comprise, inter alia, a serial number, station number, station name, and/or media access control (MAC) address of the first device 2, an Internet protocol (IP) address or uniform resource locator (URL) of the third device 8, and/or port numbers. The identification information 18 is used to locate devices and control transfer of the software 25 from the third device 8 the first device 2 automatically without operator (i.e., human input) intervention (i.e., the identification information is preloaded on the second device 4 so that when a communication link is established between the second device 4 and the first device 2, the second device 4 will transmit identification information 18, thereby allowing an installation of software from the third device 8 to the first device 2 to take place unattended). During the transmission of the identification information 18, the second device may push the identification information 18 into the first device through the communication link 20 and the identification information 18 may be stored in the memory device 28 or alternatively the identification information 18 may be stored in a separate memory device (e.g., as shown by storage device 29 in FIG. 2). As an alternative during the transmission of the identification information 18, the first device 2 may pull the identification information 18 from the second device 4 through the communication link 20. A record of any software modifications or changes that have been made to the first device 2, resulting from transfer of such software modifications from the third device 8, may be recorded and stored in the first device 2, second device 4, third device 8, or any combination thereof for future reference. The second device 4 may communicate with the first device 2 through the communication link 20. The communication link 20 may be a wireless link, a network link, a telephone link, an Internet link, a cable link, an Ethernet link, etc. The second device 4 may comprise a CPU 11, an input device 16, and an output device 15. The input device 16 may be any input device known to a person of ordinary skill in the art such as a keyboard, keypad, mouse, etc. The output device 15 may be any output device known to a person of ordinary skill in the art such as a monitor, printer, liquid crystal display, etc. The second device 4 may comprise memory (for storing the identification information 18) such as, inter alia, a hard disc drive, a CDROM drive, a floppy disc drive, etc. Alternatively the second device 4 may comprise an Internet server and identification information 18 may be issued from an Internet client (i.e., web browser) to the Internet server. For example, if the second device 4 has a processor 11, then the second device 4 may intentionally generate the identification information 18 by execution of program code. The third device 8 may receive the identification information 18 from the second device 4 through the communication link 35. The communication link 35 may be a wireless link, a network link, a telephone link, an Internet link, a cable link, an Ethernet link, etc. The third device 8 or the first device 2 may receive the identification information from a location other than the second device 4. The second device 4 provides a mechanism to identify, locate, and configure the first device 2 without any prior identification information 18 established on the first device 2. Once the first device 2 is identified and found by the second device 4, an automatic retrieval of the software from the third device 8 to the first device 2 may be performed and thus input is not required at the first device 2. Furthermore, an operator is not required at the first device 2 or the third device 8. After a transfer of software between the first device 2 and the third device 8 has been completed, communications through the communication link 20 may be terminated from the first device 2 and a fourth device that is the same as the first device 2 may replace the first device 2 and reestablish communications though the communication link 20. Upon installation of the fourth device to the communication link 20, the fourth device 12 may request a transfer of software from the third device 8. The aforementioned process may be repeated with additional devices that are equivalent to the first device 2 and requiring software from the third device 8. As an alternative to using the second device 4, an operator with a computing device (i.e., computer, portable web browser, hand-held computer, palm pilot, etc) in a remote location may be used to provide the identification information 18 for the first device 2 or any additional devices that are equivalent to the first device 2, although the process would require human input unless the computing device internally generates the identification information 18 by execution of stored program code.

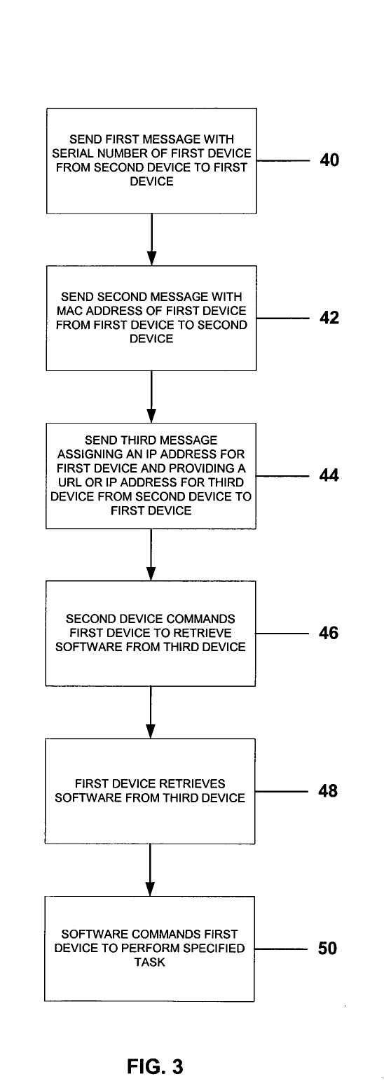

FIG. 3 illustrates flowchart depicting an algorithm showing a first embodiment based on the system of FIG. 1 assuming that the second device 4 of FIG. 1 already comprises the identification information 18 including a serial number and an IP address of the first device and an IP address or URL of the third device. However, the identification information 18 may be inputted to the second device 4 from an input device 16. The communication link 12 is established between the first device 2 and the third device 8. When the communication link 20 comprising a network topography that will pass a broadcast message (i.e., port number) is established between the second device 4 and the first device 2, the second device 4 broadcasts a first message that will be recognized by the first device 2, as shown in FIG. 3, step 40. The first message includes the serial number of the first device 2. Upon receipt of the first message, the first device 2 recognizes it's own serial number in the first message and responds by sending a second message to the second device 4, said second message comprising the MAC address of the first device 2, as shown in FIG. 3, step 42. In response to the second message comprising the MAC address, a third message is sent from the second device 4 to the MAC address of the first device 2, assigning to the first device 2 an IP address, station number and/or station name, as shown in FIG. 3, step 44. The third message from the second device 4 to the first address also provides a URL or IP address of the third device 8, wherein the third device 8, contains the software 25. Upon completion of the aforementioned process a command is issued from the second device 4 instructing the first device 2 to retrieve software 25 from the third device, as shown in FIG. 3, step 46. The first device 2 using pre-established protocols, including file transfer protocol (FTP) retrieves the software 25 from the third device 8 as shown in FIG. 3, step 48. The software 25 may include a start-up script describing a sequence of actions required to initialize execution of programs in the first device 2. Upon completion of the retrieval of the software 25 by the first device 2, the startup script is automatically triggered placing the first device 2 in an operational state to perform a specific task as shown in FIG. 3, step 50. Examples of said tasks include, inter alia, initializing hardware on the first device 2, controlling hardware on the first device 2, etc.

A second embodiment (based on FIG. 1) is a variation of the first embodiment. In contrast with the first embodiment, a telephone connection is used for the communication links 20 and 12. The first device 2, the third device 8, and the second device 4, must each comprise a telephone modem. In contrast with the first embodiment, the identification information 18 comprises telephone numbers of each modem. The second device 4 dials up the first device 2 and assigns to the first device 2 a station number and/or station name and downloads a phone number of the third device 8. The second device 4 now commands the first device 2 to retrieve software 25 from the third device 8. The phone connection from the second device 4 to the first device 2 may be disabled and the first device 2 may now dial the third device 8. Upon connection of the first device 2 to the third device 8, the software 25 is retrieved by the first device 2 and the first device 2 is placed in an operational state as described in the first embodiment.

The present invention includes similar embodiments as discussed supra in which the second device 4 gathers the identification information 18, but the process is reversed in that the identification information 18 transferred from the second device 4 is initiated by the third device 8 rather than by the first device 2.

FIG. 2 illustrates a variation of FIG. 1 showing a block diagram view of a system 5 to remotely install software 25 from a third device 8 to a first device 2 using identification information 18 on a storage device 29, in accordance with embodiments of the present invention. In contrast with FIG. 1 the first device 2 is mechanically and electrically attached (i.e., using a connector, backplane connector, etc) to the storage device 29. The storage device 29 may comprise, inter alia, electrically erasable programable read only memory (EEPROM), a memory stick, a hard disc drive, a floppy disc drive, etc. In this embodiment, it is assumed that the storage device 29 has already received the identification information 18 from an outside source (e.g., the storage device 29 may have received the identification information 18 from the second device 4 of FIG. 1). The first device 2 is attached to the storage device 29 and the identification information 18 on the storage device 29 initiates a download of the software 25 from the third device 8 to the first device 2 through a communication link 12. After a transfer of the software 25 between the first device 2 and the third device 8 has been completed, communications through the communication link 12 may be terminated from the first device 2 and the first device 2 may be unattached from the storage device 29. A fourth device that is the same as the first device 2 may be atrtached to the storage device 29, replacing the first device 2 and reestablishing communications though the communication link 12. Upon installation of the fourth device to the communication link 12 and storage device 29, the fourth device may request a transfer of software 25 from the third device 8 using the same configuration information 18 that is in the storage device 29. The aforementioned process may be repeated with additional devices that are equivalent to the first device 2 and requiring software from the third device 8. The communication link 12 may be the same as the communication link 12 in FIG. 1. In all other aspects, FIG. 2 includes all embodiments discussed supra in conjunction with FIG. 1.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A system to remotely install software, comprising:
a first device, wherein the first device is adapted to receive software from a third device comprising the software over a communication link between the first device and the third device, wherein a second device is adapted to transmit identification information to the first device over a communication link between the first device and the second device or the second device is adapted to transmit identification information to the third device over a communication link between the second device and the third device, and wherein the identification information is adapted to initiate a download of the software from the third device to the first device over the communication link between the first device and the third device without a user input to the first device.

2. The system of claim 1, wherein the communication link between the first device and the third device comprises a Ethernet connection.

3. The system of claim 1, wherein the communication link between the first device and the third device comprises an Internet connection.

4. The system of claim 1, wherein the communication link between the first device and the third device comprises a telephone connection.

5. The system of claim 1, wherein the communication link between the first device and the second device comprises a Ethernet connection.

6. The system of claim 1, wherein the communication link between the first device and the second device comprises a Internet connection.

7. The system of claim 1, wherein the communication link between the first device and the second device comprises a telephone connection.

8. The system of claim 1, wherein the communication link between the second device and the third device comprises a Ethernet connection.

9. The system of claim 1, wherein the communication link between the second device and the third device comprises an Internet connection.

10. The system of claim 1, wherein the communication link between the second device and the third device comprises a telephone connection.

11. The system of claim 1, wherein the first device is selected from the group consisting of an embedded controller and a computer.

12. The system of claim 1, wherein the second device comprises a computer.

13. The system of claim 1, wherein the third device comprises memory.

14. The system of claim 13, wherein the memory is selected from the group consisting of an electrically erasable programable read only memory (EEPROM), a compact flash card, flash memory, a memory stick, a multimedia memory card, a floppy disc drive, a hard disc drive, a compact disc drive, and a digital video disc drive.

15. The system of claim 1, wherein the software is selected from the group consisting of firmware, operating system software, executable programs, scheduled software modifications, process instructions, and updating software.

16. The system of claim 1, wherein the first device is adapted to pull the software from the third device after the first device receives the identification information from the second device.

17. The system of claim 1, wherein the third device is adapted to push the software into the first device after the third device receives the identification information from the second device.

18. The system of claim 1, wherein the first device is adapted to be replaced by a fourth device, and wherein the fourth device is equivalent to the first device.

19. A system to remotely install software, comprising:
a third device, wherein the third device comprises software, wherein a second device is adapted to transmit identification information to a first device over a communication link between the first device and the second device or the second device is adapted to transmit identification information to the third device over a communication link between the second device and the third device, and wherein the identification information is adapted to initiate a download of the software from the third device to the first device over a communication link between the first device and the third device without a user input to the first device.

20. The system of claim 19, wherein the communication link between the first device and the third device comprises a Ethernet connection.

21. The system of claim 19, wherein the communication link between the first device and the third device comprises an Internet connection.

22. The system of claim 19, wherein the communication link between the first device and the third device comprises a telephone connection.

23. The system of claim 19, wherein the communication link between the first device and the second device comprises a Ethernet connection.

24. The system of claim 19, wherein the communication link between the first device and the second device comprises a Internet connection.

25. The system of claim 19, wherein the communication link between the first device and the second device comprises a telephone connection.

26. The system of claim 19, wherein the communication link between the second device and the third device comprises a Ethernet connection.

27. The system of claim 19, wherein the communication link between the second device and the third device comprises an Internet connection.

28. The system of claim 19, wherein the communication link between the second device and the third device comprises a telephone connection.

29. The system of claim 19, wherein the first device is selected from the group consisting of an embedded controller and a computer.

30. The system of claim 19, wherein the second device comprises a computer.

31. The system of claim 19, wherein the third device comprises memory.

32. The system of claim 31, wherein the memory is selected from the group consisting of an electrically erasable programable read only memory (EEPROM), a compact flash card, flash memory, a memory stick, a multimedia memory card, a floppy disc drive, a hard disc drive, a compact disc drive, and a digital video disc drive.

33. The system of claim 19, wherein the software is selected from the group consisting of firmware, operating system software, executable programs, scheduled software modifications, process instructions, and updating software.

34. The system of claim 19, wherein the first device is adapted to pull the software from the third device after the first device receives the identification information from the second device.

35. The system of claim 19, wherein the third device is adapted to push the software into the first device after the third device receives the identification information from the second device.

36. The system of claim 19, wherein the first device is adapted to be replaced by a fourth device, and wherein the fourth device is equivalent to the first device.

37. A system to remotely install software, comprising:
a second device, wherein the second device is adapted to transmit identification information to a first device over a communication link between the first device and the second device or the second device is adapted to transmit identification information to a third device over a communication link between the third device and the second device, wherein the third device comprises software, and wherein the identification information is adapted to initiate a download of the software from the third device to the first device over a communication link between the first device and the third device without a user input to the first device.

38. The system of claim 37, wherein the communication link between the first device and the third device comprises a Ethernet connection.

39. The system of claim 37, wherein the communication link between the first device and the third device comprises an Internet connection.

40. The system of claim 37, wherein the communication link between the first device and the third device comprises a telephone connection.

41. The system of claim 37, wherein the communication link between the first device and the second device comprises a Ethernet connection.

42. The system of claim 37, wherein the communication link between the first device and the second device comprises a Internet connection.

43. The system of claim 37, wherein the communication link between the first device and the second device comprises a telephone connection.

44. The system of claim 37, wherein the communication link between the second device and the third device comprises a Ethernet connection.

45. The system of claim 37, wherein the communication link between the second device and the third device comprises an Internet connection.

46. The system of claim 37, wherein the communication link between the second device and the third device comprises a telephone connection.

47. The system of claim 37, wherein the first device is selected from the group consisting of an embedded controller and a computer.

48. The system of claim 37, wherein the second device comprises a computer.

49. The system of claim 37, wherein the third device comprises memory.

50. The system of claim 49, wherein the memory is selected from the group consisting of an electrically erasable programable read only memory (EEPROM), a compact flash card, flash memory, a memory stick, a multimedia memory card, a floppy disc drive, a hard disc drive, a compact disc drive, and a digital video disc drive.

51. The system of claim 37, wherein the software is selected from the group consisting of firmware, operating system software, executable programs, scheduled software modifications, process instructions, and updating software.

52. The system of claim 37, wherein the first device is adapted to pull the software from the third device after the first device receives the identification information from the second device.

53. The system of claim 37, wherein the third device is adapted to push the software into the first device after the third device receives the identification information from the second device.

54. The system of claim 37, wherein the first device is adapted to be replaced by a fourth device, and wherein the fourth device is equivalent to the first device.

55. A system to remotely install software, comprising:
a first device, wherein the first device is adapted to receive software from a third device comprising the software over a communication link between the first device and the third device, wherein a storage device is electrically and mechanically attached to the first device, wherein the storage device is adapted to transmit identification information to the first device, and wherein the identification information is adapted to initiate a download of the software from the third device to the first device over the communication link between the first device and the third device without a user input to the first device.

56. The system of claim 55, wherein the communication link between the first device and the third device comprises a Ethernet connection.

57. The system of claim 55, wherein the communication link between the first device and the third device comprises an Internet connection.

58. The system of claim 55, wherein the communication link between the first device and the third device comprises a telephone connection.

59. The system of claim 55, wherein the first device is selected from the group consisting of an embedded controller and a computer.

60. The system of claim 55, wherein the storage device comprises memory.

61. The system of claim 55, wherein the memory is selected from the group consisting of an electrically erasable programable read only memory (EEPROM), a compact flash card, flash memory, a memory stick, a multimedia memory card, a floppy disc drive, a hard disc drive, a compact disc drive, and a digital video disc drive.

62. The system of claim 55, wherein the software is selected from the group consisting of firmware, operating system software, executable programs, scheduled software modifications, process instructions, and updating software.

63. The system of claim 55, wherein the first device is adapted to pull the software from the third device after the first device receives the identification information from the storage device.

64. The system of claim 55, wherein the first device is adapted to be subsequently unattached from the storage device.

65. The system of claim 64, wherein the first device is adapted to be replaced by a fourth device, wherein the fourth device is equivalent to the first device, and wherein the fourth device is adapted to receive the software from the third device.

66. The system of claim 55, wherein the first device is electrically and mechanically attached to the storage device using a backplane connector.

67. A system to remotely install software, comprising:
a third device, wherein the third device comprises software, wherein a storage device is electrically and mechanically attached to a first device, wherein the storage device is adapted to transmit identification information to the first device, and wherein the identification information is adapted to initiate a download of the software from the third device to the first device over a communication link between the first device and the third device without a user input to the first device.

68. The system of claim 67, wherein the communication link between the first device and the third device comprises a Ethernet connection.

69. The system of claim 67, wherein the communication link between the first device and the third device comprises an Internet connection.

70. The system of claim 67, wherein the communication link between the first device and the third device comprises a telephone connection.

71. The system of claim 67, wherein the first device is selected from the group consisting of an embedded controller and a computer.

72. The system of claim 67, wherein the storage device comprises memory.

73. The system of claim 72, wherein the memory is selected from the group consisting of an electrically erasable programable read only memory (EEPROM), a compact flash card, flash memory, a memory stick, a multimedia memory card, a floppy disc drive, a hard disc drive, a compact disc drive, and a digital video disc drive.

74. The system of claim 67, wherein the software is selected from the group consisting of firmware, operating system software, executable programs, scheduled software modifications, process instructions, and updating software.

75. The system of claim 67, wherein the first device is adapted to pull the software from the third device after the first device receives the identification information from the storage device.

76. The system of claim 67, wherein the first device is adapted to be subsequently unattached from the storage device.

77. The system of claim 76, wherein the first device is adapted to be replaced by a fourth device, wherein the fourth device is equivalent to the first device, and wherein the forth device is adapted to receive the software from the third device.

78. The system of claim 67, wherein the first device is electrically and mechanically attached to the storage device using a backplane connector.

79. A method for installing software in a first device, comprising the steps of:
receiving, by the first device, identification information from a second device over a communication link between the first device and the second device or receiving, by a third device, identification information from the second device over a communication link between the third device and the second device; and
receiving the software, by the first device from the third device over a communication link between the first device and the third device, in accordance with the identification information and without user input to the first device.

80. The method of claim 79, wherein the step of receiving software comprises pulling the software from the third device into the first device over the communication link between the first device and the third device after the first device receives the identification information from the second device.

81. The method of claim 79, wherein the step of receiving software results from pushing the software into the first device by the third device over the communication link between the first device and the third device after the third device receives the identification information from the second device.

82. The method of claim 79, wherein the communication link between the first device and the third device comprises an Ethernet connection.

83. The method of claim 79, wherein the communication link between the first device and the third device comprises an Internet connection.

84. The method of claim 79, wherein the communication link between the first device and the third device comprises a telephone connection.

85. The method of claim 79, wherein the communication link between the first device and the second device comprises an Ethernet connection.

86. The method of claim 79, wherein the communication link between the first device and the second device comprises an Internet connection.

87. The method of claim 79, wherein the communication link between the first device and the second device comprises a telephone connection.

88. The method of claim 79, wherein the communication link between the second device and the third device comprises an Ethernet connection.

89. The method of claim 79, wherein the communication link between the second device and the third device comprises an Internet connection.

90. The method of claim 79, wherein the communication link between the second device and the third device comprises a telephone connection.

91. The method of claim 79, wherein the second device comprises a computer.

92. The method of claim 79, wherein the third device comprises memory.

93. The method of claim 92, wherein the memory is selected from the group consisting of an electrically erasable programable read only memory (EEPROM), a compact flash card, flash memory, a memory stick, and a multimedia memory card, a floppy disc drive, a compact disc drive, hard disc drive, and a digital video disc drive.

94. The method of claim 79, wherein the software is selected from the group consisting of firmware, operating system software, executable program, scheduled software modifications, process instructions, and updating software.

95. The method of claim 79, further comprising replacing the first device with a fourth device, and wherein the fourth device is equivalent to the first device.

96. The method of claim 79, wherein the first device is selected from the group consisting of an embedded controller and a computer.

97. A method for installing software in a first device, comprising the step of transmitting, by a second device, identification information to the first device over a communication link between the first device and the second device or transmitting, by the second device, identification information to a third device over a communication link between the second device and the third device, wherein the first device is adapted to receive the software from a third device over the communication link between the first device and the third device in accordance with the identification information and without user input to the first device.

98. The method of claim 97, wherein the communication link between the first device and the third device comprises an Ethernet connection.

99. The method of claim 97, wherein the communication link between the first device and the third device comprises an Internet connection.

100. The method of claim 97, wherein the communication link between the first device and the third device comprises a telephone connection.

101. The method of claim 97, wherein the communication link between the first device and the second device comprises an Ethernet connection.

102. The method of claim 97, wherein the communication link between the first device and the second device comprises an Internet connection.

103. The method of claim 97, wherein the communication link between the first device and the second device comprises a telephone connection.

104. The method of claim 97, wherein the communication link between the second device and the third device comprises an Ethernet connection.

105. The method of claim 97, wherein the communication link between the second device and the third device comprises an Internet connection.

106. The method of claim 97, wherein the communication link between the second device and the third device comprises a telephone connection.

107. The method of claim 97, wherein the second device comprises a computer.

108. The method of claim 97, wherein the third device comprises memory.

109. The method of claim 108, wherein the memory is selected from the group consisting of an electrically erasable programable read only memory (EEPROM), a compact flash card, flash memory, a memory stick, and a multimedia memory card, a floppy disc drive, a compact disc drive, hard disc drive, and a digital video disc drive.

109. The method of claim 97, wherein the software is selected from the group consisting of firmware, operating system software, executable programs, scheduled software modifications, process instructions, and updating software.

110. The method of claim 97, further comprising replacing the first device with a fourth device, and wherein the fourth device is equivalent to the first device.

111. The system of claim 97, wherein the first device is selected from the group consisting of an embedded controller and a computer.

112. A method for installing software in a first device, comprising the step of transmitting, by a third device, the software to the first device over a communication link between the first device and the third device without user input to the first device, in accordance with identification information received by the first device from a second device over a communication link between the first device and the second device or in accordance with identification information received by the third device from the second device over a communication link between the third device and the second device.

113. The method of claim 112, wherein the step of receiving software comprises pulling the software from the third device into the first device over the communication link between the first device and the third device after the first device receives the identification information from the second device.

114. The method of claim 112, wherein the step of receiving software results from pushing the software into the first device by the third device over the communication link between the first device and the third device after the third device receives the identification information from the second device.

115. The method of claim 112, wherein the communication link between the first device and the third device comprises an Ethernet connection.

116. The method of claim 112, wherein the communication link between the first device and the third device comprises an Internet connection.

117. The method of claim 112, wherein the communication link between the first device and the third device comprises a telephone connection.

118. The method of claim 112, wherein the communication link between the first device and the second device comprises an Ethernet connection.

119. The method of claim 112, wherein the communication link between the first device and the second device comprises an Internet connection.

120. The method of claim 112, wherein the communication link between the first device and the second device comprises a telephone connection.

121. The method of claim 112, wherein the communication link between the second device and the third device comprises an Ethernet connection.

122. The method of claim 112, wherein the communication link between the second device and the third device comprises an Internet connection.

123. The method of claim 112, wherein the communication link between the second device and the third device comprises a telephone connection.

124. The method of claim 112, wherein the second device comprises a computer.

125. The method of claim 112, wherein the third device comprises memory.

126. The method of claim 125, wherein the memory is selected from the group consisting of an electrically erasable programable read only memory (EEPROM), a compact flash card, flash memory, a memory stick, and a multimedia memory card, a floppy disc drive, a compact disc drive, hard disc drive, and a digital video disc drive.

127. The method of claim 112, wherein the software is selected from the group consisting of firmware, operating system software, executable program, scheduled software modifications, process instructions, and updating software.

128. The method of claim 112, further comprising replacing the first device with a fourth device, and wherein the fourth device is equivalent to the first device.

129. The system of claim 112, wherein the first device is selected from the group consisting of an embedded controller and a computer.

130. A method for installing software in a first device, comprising the steps of:
receiving, by the first device, identification information from a storage device that is electrically and mechanically attached to the first device; and
receiving the software, by the first device from a third device over a communication link between the first device and the third device, in accordance with the identification information and without user input to the first device.

131. The method of claim 130, wherein the communication link between the first device and the third device comprises a Ethernet connection.

132. The method of claim 130, wherein the communication link between the first device and the third device comprises an Internet connection.

133. The method of claim 130, wherein the communication link between the first device and the third device comprises a telephone connection.

134. The method of claim 130, wherein the first device is selected from the group consisting of an embedded controller and a computer.

135. The method of claim 130, wherein the step of receiving software comprises pulling the software from the third device into the first device over the communication link between the first device and the third device.

136. The method of claim 130, further comprising unattaching the first device from the storage device.

137. The method of claim 136, further comprising replacing the first device with a fourth device, wherein the fourth device is equivalent to the first device, and
receiving the software by the fourth device from the third device.

138. The method of claim 130, wherein the storage device comprises memory.

139. The method of claim 138, wherein the memory is selected from the group consisting of an electrically erasable programable read only memory (EEPROM), a compact flash card, flash memory, a memory stick, and a multimedia memory card, a floppy disc drive, a compact disc drive, hard disc drive, and a digital video disc drive.

140. The method of claim 130, wherein the software is selected from the group consisting of firmware, operating system software, executable program, scheduled software modifications, process instructions, and updating software.

141. The method of claim 130, wherein the first device is selected from the group consisting of an embedded controller and a computer.

142. The method of claim 130, further comprising attaching the first device to the storage device using a backplane connector.

143. A method for installing software in a first device, comprising the step of transmitting, by a third device, the software to the first device over a communication link between the first device and the third device without user input to the first device, in accordance with identification information received from a storage device that is electrically and mechanically attached to the first device.

144. The method of claim 143, wherein the communication link between the first device and the third device comprises a Ethernet connection.

145. The method of claim 143, wherein the communication link between the first device and the third device comprises an Internet connection.

146. The method of claim 143, wherein the communication link between the first device and the third device comprises a telephone connection.

147. The method of claim 143, wherein the first device is selected from the group consisting of an embedded controller and a computer.

148. The method of claim 143, wherein the storage device comprises memory.

149. The method of claim 148, wherein the memory is selected from the group consisting of an electrically erasable programable read only memory (EEPROM), a compact flash card, flash memory, a memory stick, and a multimedia memory card, a floppy disc drive, a compact disc drive, hard disc drive, and a digital video disc drive.

150. The method of claim 143, wherein the software is selected from the group consisting of firmware, operating system software, executable program, scheduled software modifications, process instructions, and updating software.

151. The method of claim 143, wherein the first device is selected from the group consisting of an embedded controller and a computer.

152. The method of claim 14, further comprising attaching the first device to the storage device using a backplane connector.
